(19) United States
(12) Patent Application Publication
(10) Pub. No.: US 2019/0284310 A1
(43) Pub. Date: Sep. 19, 2019

(54) Catalyst Supply System and Process for Producing Polymers

(71) Applicant: ExxonMobil Chemical Patents Inc., Baytown, TX (US)

(72) Inventors: Richard B. PANNELL, Liberty, TX (US); Ryan W. IMPELMAN, Houston, TX (US)

(21) Appl. No.: 16/344,173

(22) PCT Filed: Oct. 4, 2017
(86) PCT No.: PCT/US2017/055132

§ 371 Date: Apr. 23, 2019

Related U.S. Application Data
(60) Provisional application No. 62/416,755, filed on Nov. 3, 2016.

(51) Int. Cl. C08F 2/01; C08F 210/16; C08F 210/06; C08F 2/34; C08F 4/6592; C08F 4/659

(52) U.S. Cl. CPC C08F 2/01; C08F 210/16; C08F 210/06; C08F 2/34; C08F 2410/04; C08F 4/65927; C08F 4/65916; C08F 2500/04; C08F 2500/05; C08F 4/65925

(57) ABSTRACT

A polymerization catalyst supply system is provided. The polymerization catalyst supply system can be used to prepare polyolefin polymers with multimodal or broad molecular weight distribution, or to prepare polyolefins having broad compositional distribution. A process for preparing polyolefin polymers using the polymerization catalyst supply system is also provided.

### CROSS REFERENCE TO RELATED APPLICATIONS

This application claims the benefit of Ser. No. 62/416,755, filed Nov. 3, 2016, the disclosure of which is hereby incorporated by reference in its entirety.

### FIELD OF THE INVENTION

This invention relates to catalyst supply systems and polymerization processes using the same for producing polyolefin polymers having at least one of a broad molecular weight distribution and a broad composition distribution.

### BACKGROUND OF THE INVENTION

Polyolefin polymers are of great use in industry and are the materials from which many everyday products are made. In order to provide products having various desired properties, polyolefin polymers having different properties, for example, broad or multimodal molecular weight or composition, have been produced. Efforts to provide broad or multimodal molecular weight or composition polymers include mechanical mixing of polyolefins having different molecular weights, polymerizing olefins in multiple stages or reactors, polymerizing olefins with multiple catalysts, and other approaches.

Mechanical mixing or blending of polymers having different molecular weights and compositions has been performed to produce polymers having broad or multimodal molecular weight distributions and compositions. However, mechanical methods of producing such polymers are limited by the physical mixing of the original polymers produced by separate processes and will produce polymers having properties different from a polymer having a similarly broad or multimodal molecular weight distribution or composition produced in a single process.

U.S. Patent Application Publication No. 2016/0009839 describes a multi-stage polymerization process to produce polymers having controlled compositions and molecular weights. A multimodal polyolefin is produced by polymerizing olefins in the presence of a metallocene catalyst system in a slurry-phase polymerization stage and a gas-phase polymerization stage arranged in series operating under different reactor conditions to produce the various portions of the ultimate polymer.

Similarly, others have produced polyolefins having selected properties, for example, a broad or multimodal molecular weight distribution, via a process utilizing two or more reactors operated in series. U.S. Patent Application Publication No. 2016/0108149 describes polymerizing at least one monomer in a first loop reactor in the presence of a catalyst to produce a first polyolefin fraction, transferring the first polyolefin fraction to a second loop reactor connected in series with the first loop reactor, and polymerizing at least one monomer in the presence of a catalyst in the second loop reactor to produce a polymer resin fluff having a bimodal molecular weight distribution. In addition to the difficulty of operating multiple reactors at different conditions, the multiple reactors systems require multiple, spatially separated, feeds for the monomer and complicated catalyst supply systems that are difficult to control to produce the desired polymer properties.

U.S. Pat. No. 9,181,371 describes a catalyst system comprising a metallocene catalyst compound including at least one leaving group selected from a halo-phenoxy and a halo-alky, and a second catalyst including at least one of a non-metallocene catalyst compound and a second metallocene compound. The metallocene catalyst compound is applied as a trim catalyst to produce the major part of the bimodal polyethylene. Although one reactor may be used, the ratios and the feeding of the various catalysts and monomers are difficult to control to produce the desired polymer properties. Other background references include U.S. Patent Application Nos. 2010/249,355, 2011/196,116; WO 00/50466; and U.S. Pat. No. 6,462,149.

### SUMMARY OF THE INVENTION

According to the present invention, it has now been found that polymers with broad molecular weight distribution and/or broad composition distribution can be produced in a single reactor using at least two independently controlled catalyst feeders each supplying different proportions of at least two active catalyst components having different comonomer incorporation or different molecular weight determining properties. By controlling the catalyst feed rate through the different feeders, polymers having targeted molecular weight distribution and/or composition distribution can readily be produced.

Thus, in one aspect, the invention resides in a polymerization catalyst supply system comprising at least first and second independently controllable catalyst feeders each supplying a multi-component catalyst composition comprising (i) at least one catalyst component effective under polymerization conditions to produce a high molecular weight polymer and (ii) at least one catalyst component effective under the same polymerization conditions to produce a low molecular weight polymer, wherein the weight ratio of catalyst component (i) to catalyst component (ii) is larger in the catalyst composition supplied to the first catalyst feeder than the weight ratio of catalyst component (i) to catalyst component (ii) in the catalyst composition supplied to the second catalyst feeder.

In another aspect, the invention resides in a polymerization catalyst supply system comprising at least first and second independently controllable catalyst feeders each supplying a multi-component catalyst composition comprising (i) at least one catalyst component effective under polymerization conditions to incorporate a first amount of comonomer into a given polymer and (ii) at least one catalyst component effective under the same polymerization conditions to incorporate a second, lesser amount of the comonomer into the given polymer, wherein the weight ratio of catalyst component (i) to catalyst component (ii) is larger in the catalyst composition supplied to the first catalyst feeder than the weight ratio of catalyst component (i) to catalyst component (ii) in the catalyst composition supplied to the second catalyst feeder.

In a further aspect, the invention resides in a process for producing a polymer having a broad molecular weight distribution, the process comprising:

(a1) supplying at least one olefin to a polymerization reactor operating under polymerization conditions;

(b1) supplying to the polymerization reactor through a first catalyst feeder a first catalyst composition comprising (i) at least one catalyst component effective under the polymerization conditions to produce a high molecular weight polymer and (ii) at least one catalyst component effective under the polymerization conditions to produce a low molecular weight polymer, the catalyst components (i) and (ii) in the first catalyst composition being in a first weight ratio;

(c1) supplying to the polymerization reactor through a second catalyst feeder a second catalyst composition comprising (i) at least one catalyst component effective under the polymerization conditions to produce a high molecular weight polymer and (ii) at least one catalyst component effective under the polymerization conditions to produce a low molecular weight polymer, the catalyst components (i) and (ii) in the second catalyst composition being in a second weight ratio lower than the first weight ratio; and

(d1) separately adjusting the supply of catalyst composition to the reactor through the first and second feeders to produce a polymer having a target molecular weight distribution.

In a further aspect, the invention resides in a process for producing a polymer having a broad composition distribution, the process comprising:

(a2) supplying at least one olefin monomer and at least one comonomer to a polymerization reactor operating under polymerization conditions;

(b2) supplying to the polymerization reactor through a first catalyst feeder a multi-component catalyst composition comprising (i) at least one catalyst component effective under the polymerization conditions to produce a polymer from the monomer and incorporate a first amount of the comonomer into the polymer and (ii) at least one catalyst component effective under the polymerization conditions to produce a polymer from the monomer and incorporate a second, lesser amount of the comonomer into the polymer, the catalyst components (i) and (ii) in the first catalyst composition being in a first weight ratio;

(c2) supplying to the polymerization reactor through a second catalyst feeder a second catalyst composition comprising (i) at least one catalyst component effective under the polymerization conditions to produce a polymer from the monomer and incorporate a first amount of the comonomer into the polymer and (ii) at least one catalyst component effective under the polymerization conditions to produce a polymer from the monomer and incorporate a second, lesser amount of the comonomer into the polymer, the catalyst components (i) and (ii) in the second catalyst composition being in a second weight ratio lower than the first weight ratio; and

(d2) separately adjusting the supply of catalyst composition to the reactor through the first and second feeders to produce a polymer having a target composition distribution.

### DETAILED DESCRIPTION

Described herein are a catalyst supply system and a polymerization process using the same for producing in a single reactor olefin polymers having at least one of a broad molecular weight distribution and a broad composition distribution.

As used herein the term “broad molecular weight distribution” is intended to cover polymer products containing a wide spectrum of molecular weights varying continuously or substantially continuously from a first low value to a second higher value without individual peaks being discernible on an SEC curve (GPC chromatogram), as well as products having multimodal, for example, bimodal, molecular weight distributions, where two or more separate peaks are discernible on an SEC curve (GPC chromatogram). One measure of the broadness of the molecular weight distribution of a polymer is the polydispersity index, which is equal to the weight average molecular weight (Mw) divided by the number average molecular weight (Mn). The ratio Mw/Mn can be measured directly by gel permeation chromatography techniques as are well known in the art. Broad molecular weight distribution polymers produced by the present process may have a polydispersity index of at least 2, such as at least 4, for example from 2 to 10. Broad molecular weight distribution polymers may be homopolymers or copolymers.

The term “composition distribution” is used herein in relation to copolymers and refers to the amount of comonomer, such as for example one or more C₃ to C₈ alpha-olefins, incorporated into the polymer chains formed from one or more monomers, such as ethylene. A “broad” composition distribution means that of the polymer chains produced, the amount of comonomer incorporated into each polymer chain varies within a broad range, whereas a “narrow” composition distribution is one where the comonomer is incorporated evenly among the polymer chains. This characteristic is often referred to as CDBI (Composition Distribution Breadth Index). Narrow composition distribution polymers generally have a CDBI of greater than 50 or 60%, the percentage referring to the weight percent of the polymer molecules having a comonomer content within 50% of the median total molar comonomer content, whereas broad composition distribution polymers generally have a CDBI of less than 50 or 40%. The CDBI of a copolymer is readily determined utilizing well known techniques for isolating individual fractions of a sample of the copolymer. One such technique is Temperature Rising Elution Fraction (TREF), as described in Wild, et al., J. Poly. Sci., Poly. Phys. Ed., vol. 20, p. 441 (1982) and U.S. Pat. No. 5,008,204.

In one embodiment, where a broad molecular weight distribution polymer is required, the catalyst supply system described herein comprises at least first and second independently controllable catalyst feeders each supplying a multi-component catalyst composition comprising (i) at least one catalyst component effective when used alone under polymerization conditions to produce a high molecular weight polymer from a given monomer composition and (ii) at least one catalyst component effective when used alone under the same polymerization conditions to produce a low molecular weight polymer from the same monomer composition, wherein the weight ratio of catalyst component (i) to catalyst component (ii) is larger in the catalyst composition supplied to the first catalyst feeder than the weight ratio of catalyst component (i) to catalyst component (ii) in the catalyst composition supplied to the second catalyst feeder.

In the present specification, the term “high molecular weight” polymer is generally used to refer to a polymer having a molecular weight in excess of 3×105 g/mol, such as in excess of 5×105 g/mol, for example in excess of 1×106 g/mol. In contrast, the term “low molecular weight” polymer is generally used to refer to a polymer having a molecular weight less than 3×105 g/mol, such as less than 1×105 g/mol, for example less than 5×105 g/mol. For purposes of the present specification, the molecular weights referenced herein are determined in accordance with the Margolies equation (“Margolies molecular weight”). To maximize the molecular weight distribution of the final polymer, it is desirable that the difference in molecular weight of the polymer produced by catalyst component (i) as compared to the molecular weight of the polymer produced by catalyst component (ii) is as large as possible, for example at least 5×104, such as at least 105.

The absolute amounts of catalyst components (i) and (ii) supplied by each of the first and second catalyst feeders is not critical but it is generally desirable that the difference between the weight ratio of catalyst component (i) to catalyst component (ii) supplied by the first catalyst feeder and the weight ratio of catalyst component (i) to catalyst component (ii) supplied by the second catalyst feeder is a large as possible to provide the widest range of polymer products without resulting in product quality issues.

The particular active catalyst components used as catalyst components (i) and (ii) are not critical provided they produce polymers with different molecular weights. Thus, for example, the catalyst components (i) and (ii) can be single site catalysts, such as metallocene catalyst, or Ziegler-Natta catalysts, or both. In this respect, it is well known certain catalysts are selective for the production of high molecular weight polymers, whereas other catalysts are selective for the production of low molecular weight polymers. For example, U.S. Pat. No. 5,055,534 describes a catalyst and process conditions for producing a very low molecular weight polyethylene, i.e., waxes or wax-resins having a molecular weight in the range 2000-4000 Da. On the other hand, U.S. Patent Application Publication No. 2016/0024238 describes a dinuclear metallocene catalyst for producing high MW olefins. WO 2013/020896 describes catalysts that can be used to produce ultrahigh molecular weight polyethylene, i.e., having a molecular weight in excess of 1×106 Da. Thus, the catalysts disclosed in these documents can be mixed in various concentrations or ratios to prepare the first and second polymerization catalysts. Examples of catalysts that produce high molecular weight polyethylene include bis(n-propylcyclopentadienyl)hafnium dimethyl (or dichloride), dimethylsilyl(n-propylcyclopentadienide) hafnium (IV) dimethyl (or dichloride) and dimethyl-bis-(1-(4,5,6,7-tetrahydro)indenyl)silylzirconium dimethyl (or dichloride). Examples of catalysts that produce low molecular weight polyethylene include (n-propylcyclopentadienyl)(1,2,3,4,5-pentamethylcyclopentadienyl)zirconium dimethyl (or dichloride), (n-propylcyclopentadienyl)(1,2,3,4-tetramethylcyclopentadienyl)zirconium dimethyl (or dichloride), tetramethylcyclopentadienyl methylindenyl zirconium dimethyl (or dichloride) and [1,3-di(1-indenyl)-1,1,3,3-tetramethyldisiloxane]zirconium dimethyl (or dichloride).

The catalyst supply system described above can be used to produce polymers having a wide range of molecular weight distributions using a single polymerization reactor and without the need for complex control systems. Each catalyst feeder is separately adjusted to supply its specific ratio of catalyst component (i) and (ii) to the reactor while the reactor is maintained under polymerization conditions and also receives a supply of the desired monomer or monomers. Although described in relation to a system having two catalyst feeders, it is to be appreciated that the present process can be employed with three of more feeders each delivering a different ratio of catalyst component (i) to catalyst component (ii) to the polymerization reactor.

In some processes according to the invention, a polymer product property is measured in-line and in response the amount of multi-component catalyst composition being fed to the polymerization reaction by each feeder is altered to obtain or maintain the desired specification of the polymer product property.

In another embodiment, where a broad composition distribution polymer is required, the catalyst supply system described herein comprises at least first and second independently controllable catalyst feeders each supplying a multi-component catalyst composition comprising (i) at least one catalyst component effective under polymerization conditions to incorporate a first amount of comonomer into a given polymer and (ii) at least one catalyst component effective under the same polymerization conditions to incorporate a second, lesser amount of the comonomer into the given polymer, wherein the weight ratio of catalyst component (i) to catalyst component (ii) is larger in the catalyst composition supplied to the first catalyst feeder than the weight ratio of catalyst component (i) to catalyst component (ii) in the catalyst composition supplied to the second catalyst feeder.

The absolute amounts of catalyst components (i) and (ii) supplied by each of the first and second catalyst feeders is not critical but it is generally desirable that the difference between the weight ratio of catalyst component (i) to catalyst component (ii) supplied by the first catalyst feeder and the weight ratio of catalyst component (i) to catalyst component (ii) supplied by the second catalyst feeder is a large as possible to provide the widest range of polymer products without resulting in product quality issues.

The particular active catalyst components used as catalyst components (i) and (ii) are not critical provided they have different activity for the incorporation of comonomers into polymer chains or backbone. Thus, for example, the catalyst components (i) and (ii) can be single site catalysts, such as metallocene catalyst, or Ziegler-Natta catalysts, or both. In this respect, it is well known in the art that a polyolefin's composition distribution is largely dictated by the type of catalyst used and is typically invariable for a given catalyst system. Ziegler-Natta catalysts and chromium-based catalysts tend to produce polymers with broad composition distributions, whereas metallocene catalysts normally produce resins with narrow composition distributions. In contrast, WO 1994/003509 describes supported transition metal organoaluminum catalysts and conditions under which ethylene can be copolymerized with C₆ to C₁₀ alpha-olefins with a high rate of comonomer incorporation. On the other hand, U.S. Pat. No. 7,060,976 describes a metallocene catalyst that has a relatively low rate of comonomer incorporation. Thus, these two catalysts can be blended in different ratios or concentrations to prepare first and second polymerization catalysts to produce polyethylene with a desired composition of comonomer. Examples of catalysts that produce polyethylene with high comonomer incorporation include bis(n-propylcyclopentadienyl)hafnium dimethyl (or dichloride), dimethylsilyl(n-propylcyclopentadienide) hafnium (IV) dimethyl (or dichloride) and dimethyl-bis-(1-(4,5,6,7-tetrahydro)indenyl)silylzirconium dimethyl (or dichloride). Examples of catalysts that produce polyethylene with low comonomer incorporation include (n-propylcyclopentadienyl)(1,2,3,4,5-pentamethylcyclopentadienyl) zirconium dimethyl (or dichloride), (n-propylcyclopentadienyl)(1,2,3,4-tetramethyl cyclopentadienyl)zirconium dimethyl (or dichloride), tetramethyl cyclopentadienyl methylindenyl zirconium dimethyl (or dichloride) and [1,3-di(1-indenyl)-1,1,3,3-tetramethyldisiloxane]zirconium dimethyl (or dichloride).

The catalyst supply system described above can be used to produce polymers having a wide range of composition distributions using a single polymerization reactor and without the need for complex control systems. Each catalyst feeder is separately adjusted to supply its specific ratio of catalyst component (i) and (ii) to the reactor while the reactor is maintained under polymerization conditions and also receives a supply of the desired monomer and comonomer. Although described in relation to a system having two catalyst feeders, it is to be appreciated that the present process can be employed with three of more feeders each delivering a different ratio of catalyst component (i) to catalyst component (ii) to the polymerization reactor.

In some embodiments, the catalyst components of the multi-component catalyst composition supplied to each catalyst feeder comprise one or more active species on a particulate support. A single support can be used for both catalyst components (i) and (ii) or for catalyst components (i) and (ii).

Additionally, in all aspects of the invention, the first polymerization catalyst and the second polymerization catalyst can be dry powder catalysts. U.S. Patent Application Publication No. 2002/0034464 and U.S. Pat. No. 5,209,607 describe dry powder feeders that may be used in the invention.

In other aspects of the invention, the first polymerization catalyst and the second polymerization catalyst can be slurry catalysts. U.S. Pat. No. 6,936,226 discloses a slurry catalyst feeder that may be used. U.S. Patent Application Publication No. 2016/0108149 describes a double-loop reactor with slurry catalyst injection for olefin polymerization.

The polymerization processes of the present invention can be employed with all types of polymerization reactors, but are particularly intended for use in gas phase reactors, such as fluidized bed reactors. Generally, the first and second catalyst feeders are arranged so as to supply their respective catalyst compositions to different locations of the reactor.

The processes described herein can be employed with a wide variety of olefin monomers but are particularly intended for use in the production of homopolymers of ethylene and propylene and copolymers of ethylene and/or propylene with C₃ to C₈ alpha-olefins.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

In the Examples, melt index (I2) is measured according ASTM D-1238 (190° C., 2.16 kg) and the high load melt index (I21) is measured according ASTM D-1238 (190° C., 21.6 kg).

Density is reported in grams per cubic centimeter (g/cm³) and is determined using chips cut from plaques compression molded in accordance with ASTM D-1928 Procedure C, aged in accordance with ASTM D-618 Procedure A, and measured as specified by ASTM D-1505.

### Catalyst Compositions

Catalyst 1: Rac/meso Me₂Si(3-nPrCp)₂HfMe₂: (CpMe₅)(1-MeInd)ZrMe₂ (70:30): To a stirred vessel 1400 g of toluene was added along with 925 g of methylaluminoxane (30 wt % in toluene). To this solution 734 g of ES70 silica (available from PQ Corporation, Malvern, Pa.) (calcined at 875° C.) was added. The reactor contents were stirred for three hours at 100° C. The temperature was then reduced and the reaction mixture was allowed to cool to about 23° C. Dimethylsilyl(n-propylcyclopentadienide) hafnium (IV) dimethyl (10.06 g, 21.00 mmol) and tetramethylcyclopentadienyl methylindenyl zirconium dimethyl (2.31 g, 6.00 mmol) were then dissolved in toluene (250 g) and added to the vessel, which was allowed to stir for two more hours. The mixture was then stirred slowly and dried under a vacuum for 60 hours, after which 998 g of light yellow catalyst was obtained.

Catalyst 2: Rac/meso Me₂Si(3-nPrCp)₂HfMe₂: (CpMe₅)(1-MeInd)ZrMe₂ (80:20): To a stirred vessel 1400 g of toluene was added along with 925 g of methylaluminoxane (30 wt % in toluene). To this solution 734 g of ES70 silica (calcined at 875° C.) was added. The reactor contents were stirred for three hours at 100° C. The temperature was then reduced and the reaction mixture was allowed to cool to about 23° C. Dimethylsilyl(n-propyl cyclopentadienide) hafnium (IV) dimethyl (11.50 g, 24.00 mmol) and tetramethyl cyclopentadienyl methylindenyl zirconium dimethyl (3.47 g, 9.00 mmol) were then dissolved in toluene (250 g) and added to the vessel, which was stirred for two more hours. The mixture was then stirred slowly and dried under a vacuum for 60 hours, after which 1027 g of light yellow catalyst was obtained.

### Polymerization

Polymerization was conducted in a gas phase pilot plant reactor equipped with a catalyst feed system, a compressor for gas circulation, and a heat exchanger for temperature control. The reactor was configured with a distributor plate to support the bed of polymer granules and distribute the gas entering the reactor. A conical disengagement zone with hemispherical head was fitted to the top of the reactor. The reactor was equipped with temperature, pressure and gas composition measurement instruments and systems to control the feed of ethylene, 1-hexene, hydrogen, nitrogen, and isopentane. The reactor was also fitted with a product discharge system to periodically remove polymer granules from the reactor for bed level control. Production rate was controlled by the feed rate of catalyst to the reactor.

Catalysts 1 and 2 were used to produce polymer products. The process conditions and resulting polymer properties are shown in Table 1.

TABLE 1

| Polymer Products | 1 | 2 |
|---|---|---|
| Process Data | | |
| Pressure (kPa) | 2,069 | 2,067 |
| Temp (° C.) | 85.0 | 85.1 |
| Ethylene (mol %) | 70.04 | 69.59 |
| H₂/C₂ Ratio (ppm/mol %) | 5.73 | 5.78 |
| C₆/C₂ Ratio (mol %/mol %) | 0.0119 | 0.0129 |
| Activity (g polymer/g catalyst/hr) | 5,860 | 4,640 |
| Polymer Property Data | | |
| I₂ | 0.84 | 1.07 |
| I₂₁ | 18.21 | 25.88 |
| I₂₁/I₂ | 21.67 | 24.11 |
| Density (g/cc) | 0.9185 | 0.9201 |

The Catalysts 1 and 2 may be mixed together and fed to a reactor or the catalysts may be fed independently at predetermined feed rates to produce a range of polymer products. Under the process conditions listed in Table 1, the expected polymer products are listed in Table 2 based on the blend percentage or feed percentage of Catalyst 2.

TABLE 2

| % Catalyst 2 | I₂ | I₂₁ | Density |
|---|---|---|---|
| 0% | 0.84 | 18.2 | 0.9185 |
| 10% | 0.86 | 18.7 | 0.9186 |
| 20% | 0.88 | 19.3 | 0.9188 |
| 30% | 0.89 | 19.9 | 0.9189 |
| 40% | 0.91 | 20.6 | 0.9191 |
| 50% | 0.94 | 21.3 | 0.9192 |
| 60% | 0.96 | 22.0 | 0.9194 |
| 70% | 0.98 | 22.9 | 0.9195 |
| 80% | 1.01 | 23.8 | 0.9197 |
| 90% | 1.04 | 24.8 | 0.9199 |
| 100% | 1.07 | 25.9 | 0.9201 |

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc. are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

What is claimed is:

1. A polymerization catalyst supply system comprising at least first and second independently controllable catalyst feeders each supplying a multi-component catalyst composition comprising (i) at least one catalyst component effective under polymerization conditions to produce a high molecular weight polymer and (ii) at least one catalyst component effective under the same polymerization conditions to produce a low molecular weight polymer, wherein the weight ratio of catalyst component (i) to catalyst component (ii) is larger in the catalyst composition supplied to the first catalyst feeder than the weight ratio of catalyst component (i) to catalyst component (ii) in the catalyst composition supplied to the second catalyst feeder.

2. The polymerization catalyst supply system of claim 1, wherein each of the catalyst components (i) and (ii) comprises an active material on a particulate support.

3. The polymerization catalyst supply system of claim 1, wherein each catalyst composition is supplied by the respective feeder as a dry powder catalyst.

4. The polymerization catalyst supply system of claim 1, wherein each catalyst composition is supplied by the respective feeder as a slurry.

5. A polymerization catalyst supply system comprising at least first and second independently controllable catalyst feeders each supplying a multi-component catalyst composition comprising (i) at least one catalyst component effective under polymerization conditions to incorporate a first amount of comonomer into a given polymer and (ii) at least one catalyst component effective under the same polymerization conditions to incorporate a second, lesser amount of the comonomer into the given polymer, wherein the weight ratio of catalyst component (i) to catalyst component (ii) is larger in the catalyst composition supplied to the first catalyst feeder than the weight ratio of catalyst component (i) to catalyst component (ii) in the catalyst composition supplied to the second catalyst feeder.

6. The polymerization catalyst supply system of claim 5, wherein each of the catalyst components (i) and (ii) comprises an active material on a particulate support.

7. The polymerization catalyst supply system of claim 5, wherein each catalyst composition is supplied by the respective feeder as a dry powder catalyst.

8. The polymerization catalyst supply system of claim 5, wherein each catalyst composition is supplied by the respective feeder as a slurry.

9. A process for producing a polymer having a broad molecular weight distribution, the process comprising:
(a1) supplying at least one olefin to a polymerization reactor operating under polymerization conditions;
(b1) supplying to the polymerization reactor through a first catalyst feeder a first catalyst composition comprising (i) at least one catalyst component effective under the polymerization conditions to produce a high molecular weight polymer and (ii) at least one catalyst component effective under the polymerization conditions to produce a low molecular weight polymer, the catalyst components (i) and (ii) in the first catalyst composition being in a first weight ratio;
(c1) supplying to the polymerization reactor through a second catalyst feeder a second catalyst composition comprising (i) at least one catalyst component effective under the polymerization conditions to produce a high molecular weight polymer and (ii) at least one catalyst component effective under the polymerization conditions to produce a low molecular weight polymer, the catalyst components (i) and (ii) in the second catalyst composition being in a second weight ratio lower than the first weight ratio; and
(d1) separately adjusting the supply of catalyst composition to the reactor through the first and second feeders to produce a polymer having a target molecular weight distribution.

10. The process of claim 9, wherein the at least one olefin comprises ethylene and/or propylene.

11. The process of claim 9, wherein the polymerization reactor is operating under polymerization conditions.

12. The process of claim 9, wherein each of the catalyst components (i) and (ii) comprises an active material on a particulate support.

13. The process of claim 9, wherein each of the first and second catalyst composition is supplied to the reactor as a dry powder catalyst.

14. The process of claim 9, wherein each of the first and second catalyst composition is supplied to the reactor as a slurry.

15. A process for producing a polymer having a broad composition distribution, the process comprising:
(a2) supplying at least one olefin monomer and at least one comonomer to a polymerization reactor operating under polymerization conditions;
(b2) supplying to the polymerization reactor through a first catalyst feeder a multi-component catalyst composition comprising (i) at least one catalyst component effective under the polymerization conditions to produce a polymer from the monomer and incorporate a first amount of the comonomer into the polymer and (ii) at least one catalyst component effective under the polymerization conditions to produce a polymer from the monomer and incorporate a second, lesser amount of the comonomer into the polymer, the catalyst components (i) and (ii) in the first catalyst composition being in a first weight ratio;
(c2) supplying to the polymerization reactor through a second catalyst feeder a second catalyst composition comprising (i) at least one catalyst component effective under the polymerization conditions to produce a polymer from the monomer and incorporate a first amount of the comonomer into the polymer and (ii) at least one catalyst component effective under the polymerization conditions to produce a polymer from the monomer and incorporate a second, lesser amount of the comonomer into the polymer, the catalyst components (i) and (ii) in the second catalyst composition being in a second weight ratio lower than the first weight ratio; and
(d2) separately adjusting the supply of catalyst composition to the reactor through the first and second feeders to produce a polymer having a target composition distribution.

16. The process of claim 15, wherein the at least one olefin monomer comprises ethylene and/or propylene and the at least one comonomer comprises at least one C₃ to C₈ alpha-olefin.

17. The process of claim 15, wherein the polymerization reactor is operating under polymerization conditions.

18. The process of claim 15, wherein each of the catalyst components (i) and (ii) comprises an active material on a particulate support.

19. The process of claim 15, wherein each of the first and second catalyst composition is supplied to the reactor as a dry powder catalyst.

20. The process of claim 15, wherein each of the first and second catalyst composition is supplied to the reactor as a slurry.
